(19) United States
(12) Patent Application Publication
(10) Pub. No.: US 2006/0262187 A1
(43) Pub. Date: Nov. 23, 2006

(54) Face identification apparatus and entrance and exit management apparatus

(75) Inventor: Kei Takizawa, Kawasaki-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/443,290

(22) Filed: May 31, 2006

Related U.S. Application Data
(63) Continuation-in-part of application No. 11/363,160, filed on Feb. 28, 2006.

(30) Foreign Application Priority Data
Feb. 28, 2005 (JP) 2005-053385

(51) Int. Cl. H04N 7/18

(52) U.S. Cl. 348/77

(57) ABSTRACT

A pedestrian moves in a direction indicated by the arrow “a”, and the face of the pedestrian M facing a door provided in an entrance and exit target area is captured by cameras. Specifically, while the pedestrian M exists between a position C and a position A in the walking area, an image including at least a face of the pedestrian M is captured as an image by the cameras. While the pedestrian M reaches the door from the position A, it is determined whether or not the pedestrian M is a person who has been registered in advance, based on the captured image. In the case where the determination result is affirmative, the door is opened.

### CROSS-REFERENCE TO RELATED APPLICATIONS

This is a Continuation-in-Part application of U.S. patent application Ser. No. 11/363,160, filed Feb. 28, 2006, now abandoned, the entire contents of which are incorporated herein by reference.

This application is based upon and claims the benefit of priority from prior Japanese Patent Application No. 2005-053385, filed Feb. 28, 2005, the entire contents of which are incorporated herein by reference.

### BACKGROUND OF THE INVENTION

1. Field of the Invention

The present invention relates to a face identification apparatus for correlating dictionary information having characteristic information on pedestrian's face images registered in advance, and then, determining whether or not the pedestrian has been registered in advance; and an entrance and exit management apparatus for managing entrance and exit with respect to a room, a facility or the like which requires security by using the face identification apparatus.

2. Description of the Related Art

The entrance and exit management apparatus using the face identification apparatus has a camera for capturing a person targeted for identification as an image. When a person stops in front of the camera and turns his or her face to the camera, face images of the person are captured via the camera. Then, the entrance and exit management apparatus compares characteristic information obtained from the face images with dictionary information which has been registered in advance, and then, determines whether or not the person has been registered in advance. Further, in the case where the person has been registered in advance as a result of this determination, the entrance and exit management apparatus opens a door of an entrance and exit target area (such as a room or a facility) (refer to Jpn. Pat. Appln. KOKAI Publication No. 2001-266152, for example).

However, the entrance and exit management apparatus captures face images of a person targeted for authentication in a state in which the person stops in front of the camera. Therefore, there is a problem that it is inconvenient for such a person targeted for identification to do this. Namely, it is necessary for the person targeted for identification to wait until an identification process terminates while he or she stops in front of the camera. That is, in an entrance and exit management apparatus of this type, the face of a person who is walking cannot be captured as images in the case where an identification target is a pedestrian (a moving person). Thus, this apparatus is unsuitable as an entrance and exit management apparatus in a room or facility which a comparatively large number of people frequently come in and go out.

In contrast, in the case where a pedestrian (a moving person) is targeted for identification, a contrivance is made for reliably capturing face images of a pedestrian in comparison with a case of capturing face images of a person who stops in front of equipment. Namely, it is desirable to capture frontal face images (hereinafter, referred to as a frontal image) such that characteristics of the pedestrian's face can be well identified. As a publicly known example whose object is to capture a frontal image of a pedestrian, for example, there is known a method disclosed in Jpn. Pat. Appln. KOKAI Publication Nos. 2000-331207 and 2002-140699.

In Jpn. Pat. Appln. KOKAI Publication No. 2000-331207, the pedestrian's frontal face is captured, based on the tendency that a person is likely to face down when he or she is walking. Specifically, a camera direction is adjusted slightly upwardly from a position which is lower than the face and at the left or right side of the walking area so as to easily capture the frontal face of the pedestrian who is walking with his or her face down.

By the image capturing method disclosed in this publication, it is easy to capture a frontal face of a pedestrian who is walking with his or her face down. However, in the case where a pedestrian is walking with his or her face being straight front, frontal face images cannot be captured by the method.

In Jpn. Pat. Appln. KOKAI Publication No. 2002-140699, the invention is featured in that a camera is allocated at a position at which a pedestrian's face image can be captured when a door is opened. This invention is based on the fact that, when the pedestrian passes through a door, he or she is likely to face straight front.

However, in the image capturing method disclosed in this publication, the images of a moment at which the door is opened are captured, and thus, frontal images can be captured just momentarily. For this reason, a very small number of images can be captured. The frontal images include of important characteristics for identifying people. Thus, in the case where the number of captured frontal face images is small, the performance of identification is lowered.

Further, what is common to the above-described two publications is that it is impossible to identify which pedestrian's face is captured as images by equipment. That is, the image capturing methods disclosed in the two publications are image capturing methods in which a pedestrian is not caused to be aware of a camera.

In the case where it is presumed that face identification is carried out, it is better for a pedestrian to know that his or her face is captured as images, and is in identification because the state of equipment can be grasped. Namely, when it is identified that the face identification is in progress, there is a high possibility that the pedestrian tends to view the camera.

However, in the above-described image capturing method disclosed in the two publications, the pedestrian is not caused to be aware of the camera, so that there is a low possibility that the pedestrian faces the camera by him or herself. Thus, a frontal face cannot be well captured as images, and identification is likely to fail. In the case where authentication has failed, it is difficult for a pedestrian to identify whether he or she has been unsuccessfully identified or whether a person who is walking in front has been unsuccessfully identified. Namely, in this case, the pedestrian is unaware of knowing what to do next while he or she is inhibited to pass through a door or a gate.

### BRIEF SUMMARY OF THE INVENTION

It is an object of the present invention to provide a face identification apparatus and an entrance and exit management apparatus capable of achieving high performance of face identification with respect to a moving person.

In order to achieve the above object, a face identification apparatus according to an aspect of the present invention is a face identification apparatus for, by the time a moving person reaches a specific position, identification a face of the person, the apparatus comprising: a camera which captures images including at least a face of the moving person; a face detector module which detects face regions of the person from the images captured by the camera; a face identification module which compares the image regions of the face detected by the face detector module with dictionary entries which have been registered in advance, thereby determining whether or not the person has been registered in advance; and a face identification display module provided in the vicinity of the specific position, the display section displaying a current state of face identification with respect to the moving person, wherein the camera is provided at a position at which the face of the person moving to the specific position is captured as images from a substantially frontal face while the person is viewing the face identification display module.

Further, a face identification apparatus according to another aspect of the present invention is a face identification apparatus for, until a moving person reaches a specific position, identifying the face of the person, the apparatus comprising: a camera which captures images including the face of the moving person; a face detector module which detects a face regions from the images captured by the camera; a face identification module which compares the image regions of the face detected by the face detector module with dictionary entries which have been registered in advance, thereby determining whether or not the person has been registered in advance; a face identification display module provided in the vicinity of the specific position, the display section displaying a current state of face identification with respect to the moving person; and a face distance measuring module which calculates a distance of the moving person from the specific position, wherein the camera is provided at a position at which the face of the person moving to the specific position is captured as images from a substantially frontal face while the person is viewing the face identification display module, and the face identification display module changes display images based on the result of the face distance measuring module.

Moreover, an entrance and exit management apparatus according to still another aspect of the present invention is an apparatus for, until a moving person reaches an entrance and exit gate provided in an entrance and exit target area, identification the face of the person, and controlling the entrance and exit gate to be opened or closed based on a result of the identification, the management apparatus comprising: a camera which captures images including the face of the moving person; a face detector module which detects face regions from the images captured by the camera; a face identification module which compares the image regions of the face detected by the face detector module with dictionary entries which have been registered in advance, thereby determining whether or not the person has been registered in advance; a face identification display module provided in the vicinity of the specific position, the display section displaying a current state of face identification with respect to the moving person; and gate control means for controlling the entrance and exit gate to be opened or closed based on the result of the face identification module, wherein the camera is arranged at a position at which the face of the person moving to the entrance and exit gate is picked up as an image from a substantially frontal face while viewing the face identification display module.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a schematic view of an entrance and exit management apparatus using a face identification apparatus according to an embodiment of the present invention;

FIG. 2 is a schematic view showing a modified example of the entrance and exit management apparatus shown in FIG. 1;

FIG. 3 is a block diagram depicting a control system of the entrance and exit management apparatus shown in FIG. 1;

FIG. 4 is a view adopted to explain a configuration of a face identification display module;

FIGS. 5A to 5F are views each showing a display screen example in the face identification display module;

FIG. 6 is a view showing an illumination display module allocated at the periphery of the face identification display module;

FIG. 7 is a schematic view adopted to explain a relationship of allocating the face identification display module and the camera;

FIGS. 8A and 8B are views each adopted to explain an example of detecting face regions;

FIG. 9 is a view adopted to explain correlation of a result of the detection of the face region;

FIG. 10 is a flow chart adopted to explain a flow of a processing operation of a gate control module;

FIG. 11 is a flow chart adopted to explain a flow of a processing operation of the display identification control module;

FIG. 12 is a flow chart adopted to explain a flow of a processing operation of the display identification control module; and

FIG. 13 is a flow chart adopted to explain a flow of a processing operation of registering dictionary information.

### DETAILED DESCRIPTION OF THE INVENTION

Hereinafter, embodiments of the present invention will be described with reference to the accompanying drawings.

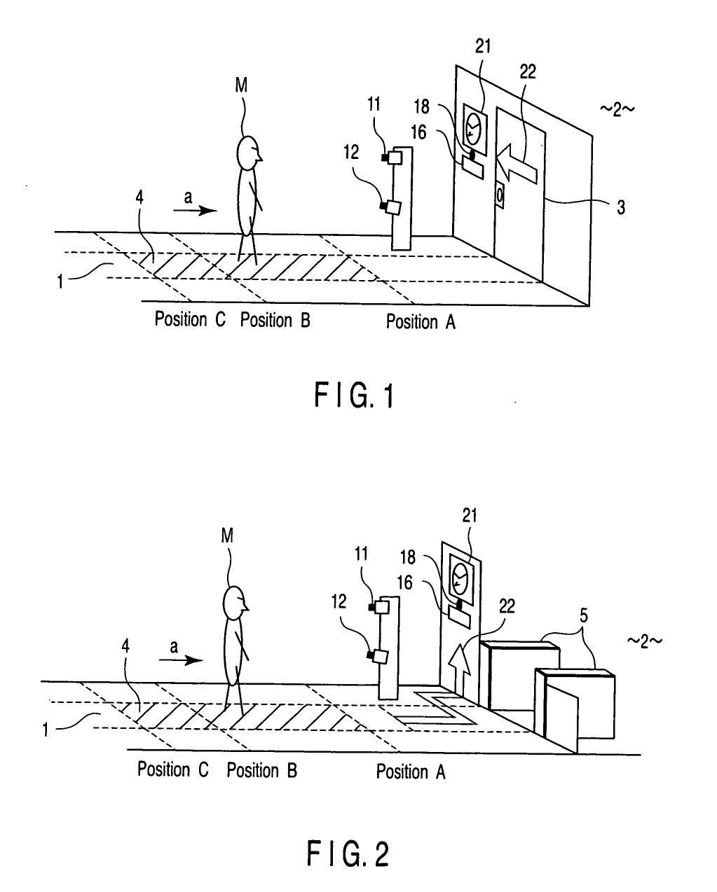

For example, as shown in FIG. 1, an entrance and exit management apparatus, to which a face identification apparatus according to an embodiment of the present invention is applied, captures as images by cameras 11 and 12 a face of a pedestrian M, while the pedestrian is moving at the walking area 1 in a direction indicated by the arrow “a”. By the time when the pedestrian reaches the door 3 (entrance and exit gate), which is provided in an entrance and exit target area (such as a room or a facility) 2, the apparatus determines whether the door 3 can be opened or not based on the captured face images.

Specifically, the entrance and exit management apparatus captures images including the face of the pedestrian M by the cameras 11 and 12 while the pedestrian M is moving from position C to position A of the walking area 1, and determines whether or not the door 3 can be opened based on the captured face images while the pedestrian M reaches from the position A to the door 3. At this time, the entrance and exist management apparatus extracts characteristic information from the face images captured by the cameras 11 and 12, and compares the extracted characteristic information with dictionary entries which have been registered in advance, thereby determining whether or not the pedestrian M has been registered in advance. Then, in the case where the determination result is that the pedestrian M has been registered in advance, the entrance and exit management apparatus opens the door 3 of the entrance and exit target area 2.

Hereinafter, the region from the position C to the position A indicated by the shaded line in FIG. 1 is referred to as an image capturing area 4. FIG. 2 illustrates an example of an entrance and exit management apparatus using the gateway unit 5 instead of the door 3. The entrance and exit management apparatus shown in FIG. 2 has the same structure as that shown in FIG. 1 expect that the gateway unit 5 is used as the door 3. Now, the entrance and exit management apparatus shown in FIG. 1 will be typically described here.

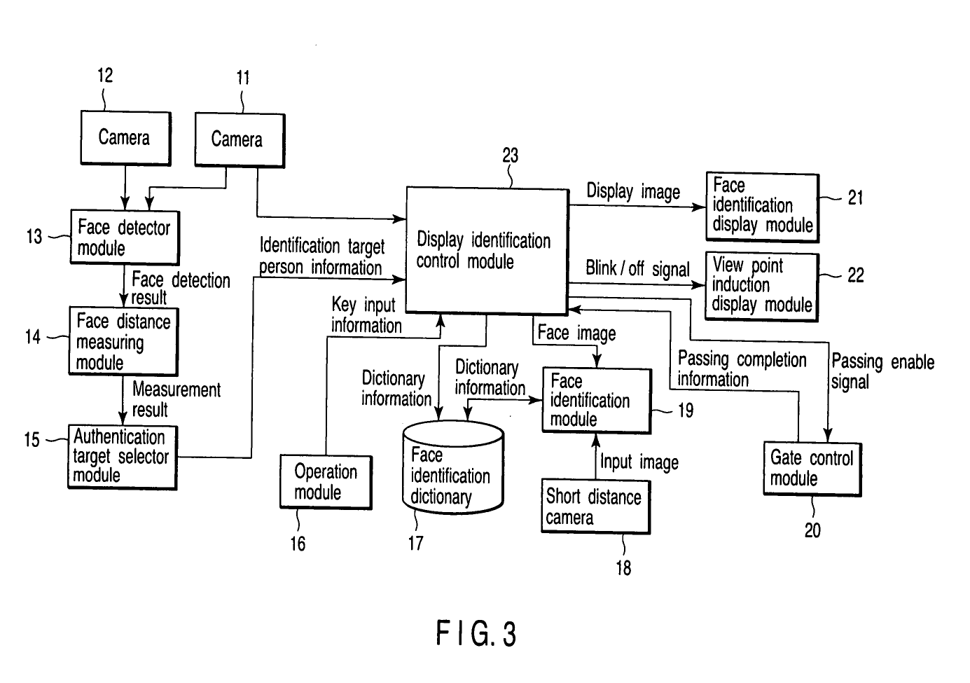

FIG. 3 is a block diagram depicting a configuration of the above-described entrance and exit management apparatus. The entrance and exit management apparatus has first and second video cameras 11 and 12 (hereinafter, simply referred to as cameras 11 and 12), a face detector module 13, a face distance measuring module 14, an identification target selector module 15, an operating module 16, a face identification dictionary 17, a short distance camera 18, a face identification module 19, a gate control module 20, a face identification display module 21, a view point induction display module 22, and a display identification control module 23.

The cameras 11 and 12 each capture images which include the face of a pedestrian M. The face detector module 13 detects face regions of the pedestrian M from each of the images captured by the cameras 11 and 12. The face distance measuring module 14 calculates the distance between the pedestrian M and each of the cameras 11 and 12. The identification target selector module 15 selects an optimal face region targeted for identification. The operation module 16 makes an input operation such as a dictionary registering operation by the pedestrian him or herself. The face identification dictionary 17 registers (stores) plural items of dictionary information in advance as characteristic information on a face specific to each person based on the face images of a person who is permitted to enter or exit from the entrance and exit target area 2. The short distance camera 18 captures images which include the face of the pedestrian M in a short distance. The face identification module 19 compares the face images, which are captured by the cameras 11 and 1 or by the short distance camera 18, with dictionary information which has been registered in advance in the face identification dictionary 17, thereby determining whether or not the pedestrian M is a person who has been registered in advance. The gate control module 20 controls opening of the door 3 (or gateway unit 5) based on the result of the face identification module 19. The face identification display module 21 displays the current status of the face identification with respect to the pedestrian M. The view point induction display module 22 displays an arrow for prompting the pedestrian M to view the face identification display module 21, and invokes the pedestrian to pay attention. The display identification control module 23 controls a whole operation of the above-described entrance and exit management apparatus.

Hereinafter, a more detailed description will be given with respect to constituent elements of the above entrance and exit management apparatus.

The face identification display module 21, for example, as shown in FIG. 1 (FIG. 2), is installed in proximity to the door 3 (or gateway unit 5). For example, as shown in FIG. 4, the display module has a plurality of illumination lamps (for example, fluorescent lamps) 32, 33, 34, and 35 arranged at around the liquid crystal display 31. The illumination lamps 32, 33, 34, and 35 each are turned off ordinarily, and are turned on only in the case where the pedestrian M carries out dictionary registration immediately in front of the face identification display module 21. The installation height of the face identification display module 21 is set to an extent equivalent to an average value of a height of the pedestrian M.

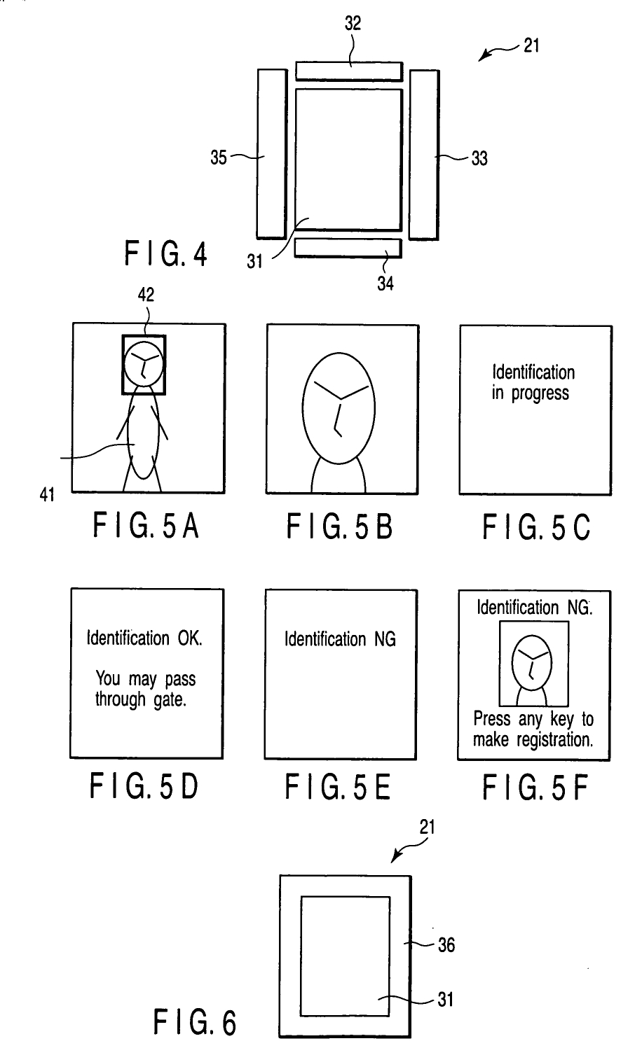

The face identification display module 21 displays the current state of the face identification with respect to the pedestrian M. Specifically, in the case where the pedestrian M is distant from the door 3, and his or her face cannot be detected, or alternatively, in the case where the detection just starts, whole images 41 captured via the camera 11, which is installed at the height of the face of the pedestrian M in FIG. 1, are is displayed as shown in FIG. 5A. A rectangle 42 located on a screen shown in FIG. 5A indicates a region of a face detected by the face detector module 13.

In the case where the face is detected, and then, the pedestrian M approaches the door 3 to a predetermined distance, more specifically, in the case where the pedestrian M approaches the camera 11 more significantly than the position B shown in FIG. 1, the face identification display module 21 displays the detected face images in an enlarged manner, as shown in FIG. 5B.

Further, in the case where the pedestrian M approaches the door 3, more specifically, in the case where the pedestrian M approaches the door 3 more significantly than the position A in FIG. 1, the face identification module 19 picks up an image via the camera 11, refers to the face identification dictionary 17 based on the face image detected by the face detector module 13, and starts identification processing as to whether or not the pedestrian has been registered in advance.

At this time, the face identification display module 21 displays a message indicating that “identification is in progress”, as shown in FIG. 5C. In this manner, the pedestrian can judge that his or her face image has been successfully captured.

In the case where, identification is terminated, and the face identification module 19 determines that the pedestrian has been registered in advance, the face identification display module 21 displays a message indicating that entrance has been permitted for the pedestrian M, as shown in FIG. 5D.

In the case where the identification fails, i.e., in the case where the face identification module 19 determines that the pedestrian has not been registered in advance, the face identification display module 21 displays a message indicating that entrance has been rejected for the pedestrian M, as shown in FIG. 5E. The display shown in FIG. 5E will be described in detail in a description of the display identification control module 23 given later.

The view point induction display module 22 is provided as a message display for prompting the pedestrian M to view the face identification display module 21, and, for example, is formed of an arrow pattern using a plurality of light emitting elements such as LEDs. This arrow pattern, a tip end of which is oriented to a direction of the face identification display module 21, is allocated in front of the pedestrian M. For example, in the case of FIG. 1, the arrow pattern is provided at the door 3, and in the case of FIG. 2, the arrow pattern is provided from the walking area 1 toward a wall on which the face identification display module 21 is installed.

In the case where the pedestrian M is spaced from the door 3 by a predetermined distance, more specifically, in the case where the pedestrian M exists between the position B and the position C shown in FIG. 1, the view point induction display module 22 is operated to blink, and induces the pedestrian M to view the face identification display module 21. In the case where the pedestrian M further approaches the door 3, more specifically, in the case where the pedestrian M exists between the position B and the position A in FIG. 1, a blinking operation of the view point induction display module 22 is stopped and turned off. The reason is as follows. When the pedestrian M is distant from the door 3 to a certain extent, the view point induction display module 22 is required to prompt the pedestrian to orient his or her face to the face identification display module 21. However, after the pedestrian has noticed the identification display module, the pedestrian watches the blinking if the view point induction display module 22 blinks, and there is a possibility that frontal face images cannot be obtained.

As another example of the view point induction display module 22, for example, as shown in FIG. 6, there may be employed an illumination display module 36 formed in a rectangular frame shape, the display module being allocated at the periphery of the liquid crystal display module 31. Although this illumination display module 36, for example, may be formed while a number of LEDs are arranged as in the above-described arrow pattern, a display may be provided such that a comparatively colorful pattern moves.

In any case, the illumination display module 36 is also operated in the case where the pedestrian M is spaced from the door 3 by a predetermined distance as in the above-described arrow pattern, more specifically, in the case where the pedestrian M exists between the position B and the position C shown in FIG. 1. This operation is stopped in the case where the pedestrian M further approaches the door 3, more specifically, in the case where the pedestrian M exists between the position B and the position A shown in FIG. 1.

In addition, the illumination display module 36 (or view point induction display module 22) may be operated in a standby state in which no pedestrian exists in the walking area 1 of the entrance and exit management apparatus. In this case, animated images capable of catching the pedestrian's attention or the like may be displayed as a standby screen via the liquid crystal display module 31 as well as the illumination display module 36 (or view point induction display module 22).

The operating module 16 is, for example, installed below the face identification display module 21, as shown in FIG. 1. The operation module 16 is used when the pedestrian M makes an identification operation while stopping in front of the face identification display module 21 or when the pedestrian enters an ID number, a password or the like by a dictionary registering operation, and includes a keyboard or a pointing device (mouse). The operation module 16 also includes a wireless communication medium possessed by a pedestrian, for example, a reader/writer for making wireless communication with a wireless ID card or a portable cellular phone.

The short distance camera 18 is installed between the face identification display module 21 and the operation module 16 as shown in FIG. 1, for example, captures face images of a person (pedestrian M) who exists in front of the face identification display module 21. Like the operating module 16, the short distance camera 18 is used in the case where the pedestrian M makes operation while stopping in front of the face identification display module 21.

An example of the pedestrian M making operation while stopping in front of the face identification display module 21 includes a case in which the pedestrian M fails in face identification while the pedestrian approaches the door 3, and then, restarts face identification in detail while stopping in front of the face identification display module 21. Alternatively, this example can include a case in which a pedestrian M having an ID number or a password for entering and exiting from the entrance and exit target area 2, the pedestrian M failing to register his or her own face image with respect to the entrance and exit management apparatus, registers characteristic information on face images picked up by the short distance camera 18 in the entrance and exit management apparatus (face identification dictionary 17).

The cameras 11 and 12 are installed so as to have a common field of view, and capture the face images of the pedestrian M who moves the walking area 1 toward the door 3. The camera 11 which is installed at the average height of the pedestrians, captures frontal face images in the case where the pedestrian M views the face identification display module 21. The camera 12 installed at a position lower than the face of the pedestrian M captures a frontal face image in the case where the pedestrian M walks with his or her face down without viewing the face identification display module 21. Further, the two cameras 11 and 12 are used for the purpose of measuring a relative position of the pedestrian M from a camera by stereo vision.

The cameras 11 and 12 are, for example, arranged in parallel in a vertical direction between the position A and the door 3 (face identification display module 21) at a position slightly displaced from the walking area 1, as shown in FIG. 1. The installation height of the upper camera 11 is set at the substantially equal height to the face identification display module 21. However, these cameras are set to be slightly lower than the face identification display module 21 such that the face identification display module 21 is not hidden by the camera 11.

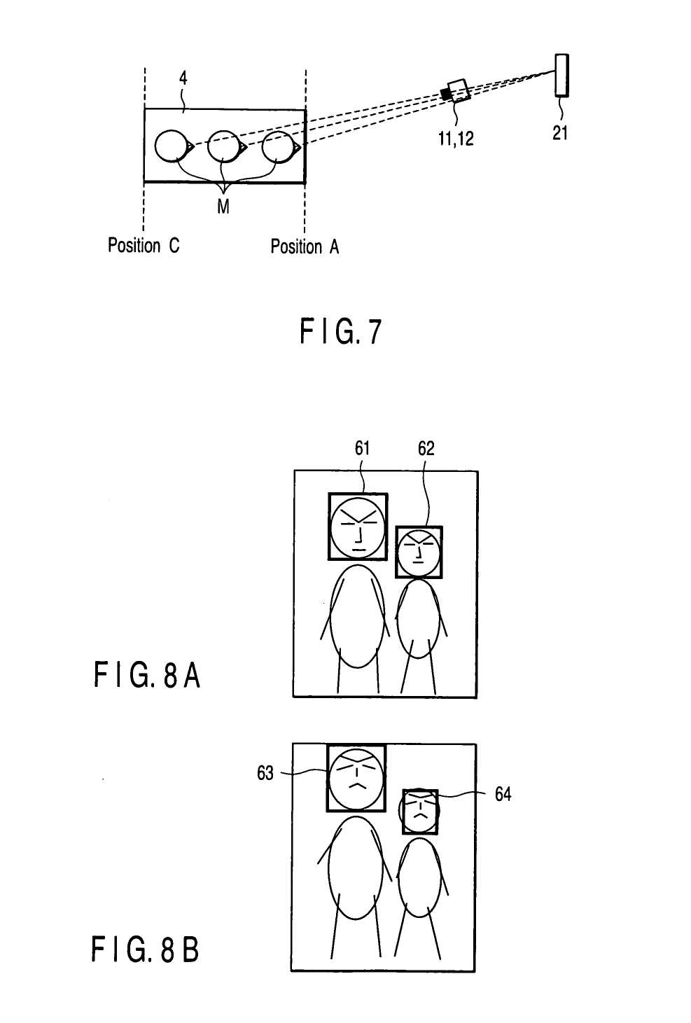

In the case where this camera installation is viewed upwardly, the camera 11 (12) is positioned, as shown in FIG. 7, in a location in which the camera overlaps on the face identification display module 21 viewed from the pedestrian M in the image capturing area 4. That is, the camera 11 (12) and the face identification display module 21 are positioned so that the camera 11 (12) and face identification display module 21 and the pedestrian M in the image capturing area 11 are arranged in a substantially straight line. In addition, the installation height of the lower camera 21 is at a position which is lightly lower than the upper camera 11. That is, the camera 12 is installed so as to look up the pedestrian M from a slightly lower position.

By the arrow pattern of the view point induction display module 22 or the illumination display module 36 and by an identification image displayed to be changed via the face identification display module 21, a pedestrian moving the walking area 1 toward the door 3 is prompted to pay attention to view the face identification display module 21, and thus, the pedestrian moves his or her view point to the camera 11 installed between the above display module and the face identification display module 21. In other words, the installation position of the camera 11 is set at a position such that, when the pedestrian M moving the walking area 1 moves his or her view point to the face identification display module 21, frontal image of the pedestrian M can be captured.

Thus, the camera 11 must not be always installed between the pedestrian M and the face identification display module 21 as shown in FIG. 7, and for example, the pedestrian M may be captured as an image while the short distance camera 18 installed near the face identification display module 21 is caused to have a telescopic function. Alternatively, a reflection mirror such as a half mirror is installed between the pedestrian M and the face identification display module 21 so as to install the camera 11 on its optical path.

The face detector module 13 detects the regions from each of the images captured by the cameras 11 and 12. For a processing operation of detecting face regions, for example, there is used the method described in document (Mita, Kaneko, Hori, “A proposal for spatial differential probability template suitable to correlation of images including very small difference”, Transaction of ninth image sensing symposium, SSII03, 2003). This method is to produce detection dictionary patterns from samples of face images in advance, and then, making a search for regions having likelihood values which are greater than a predetermined threshold from input images from the cameras 11 and 12.

FIGS. 8A and 8B each show a specific example of detecting a face region. FIG. 8A shows an image picked up by the upper camera 11; and FIG. 8B shows an image picked up by the lower camera 12, wherein the face regions detected by the face detector module 13 are displayed by frames 61, 62, 63, and 64.

The face distance measuring module 14 obtains a viewing difference by correlating the face regions detected from the images captured by the cameras 11 and 12, and calculates the distance from the cameras 11 and 12 up to the face of the pedestrian M. A correspondence of face region in the images from cameras 11 and 12 is obtained by, for example, a well known template pattern matching method.

The upper camera 11 and the lower camera 12 are arranged in a substantially vertical direction. Thus, the corresponding face region can be found by searching for the image captured by the camera 12 with respect to the face region detected by the image captured by the camera 11. Specifically, while the face region detected from the image of the camera 11 is used as a template, the image from the camera 12 is searched in a vertical direction, and a face region, where the likelihood becomes maximal, is detected as corresponding to the template.

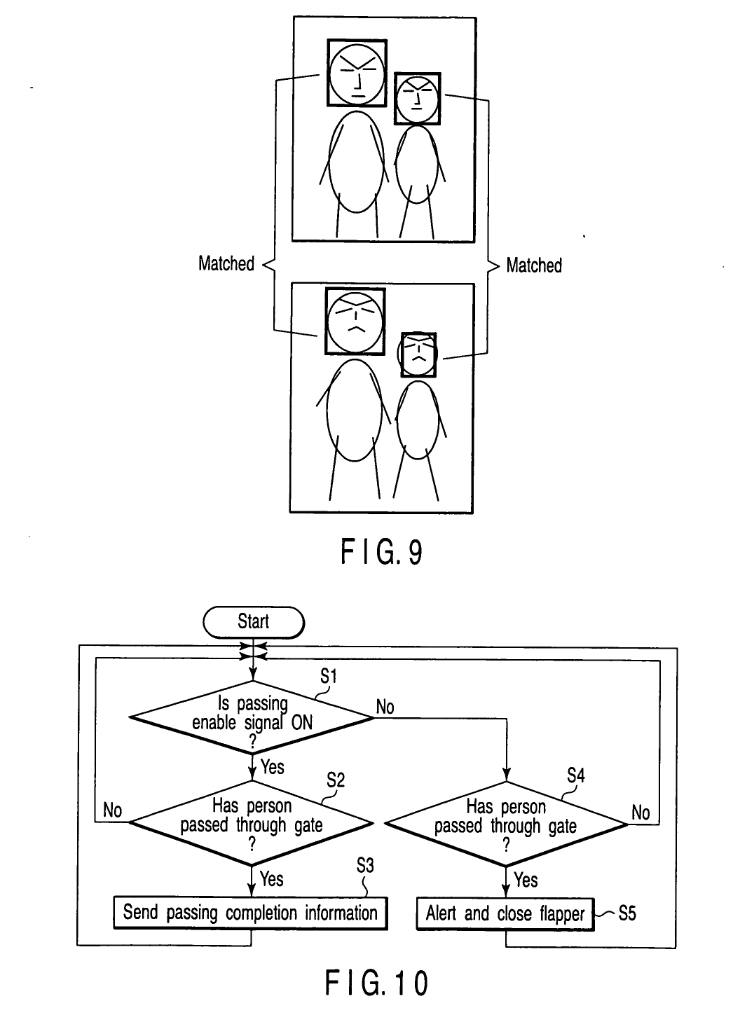

FIG. 9 shows a correspondence of between face regions detected from images which are captured by cameras 11 and 12. The region including a frontal face is selected from among a pair of face regions associated with each other. Specifically, the region having higher likelihood, which is computed by the face detector module, with a detection dictionary pattern is selected. The selected face region is used for carrying out identification by the face identification module 19. The upper portion of FIG. 9 shows an image captured by the camera 11, and the lower portion of FIG. 9 shows an image captured by the camera 12. These figures correspond to FIGS. 8A and 8B, respectively.

A positional relationship between the camera 11 or 12 and the face of the pedestrian M can be computed from the correspondence between the face regions and a positional relationship between the cameras 11 and 12. This computation is carried out by using the method disclosed in document (“Three-dimensional vision”, Kyoritsu Printing Co., Ltd., Tsuyoshi JYO et al, Chapter 7) or the like. Specifically, a direction of a face relevant to the camera 11 is calculated from the position of the face in the image of the camera 11, and a distance from the camera 11 is calculated from the position difference between the two face positions captured from cameras 11 and 12. Therefore, a three-dimensional position of the face of the pedestrian M from the cameras 11 can be calculated.

The face distance measuring module 14 outputs a set of face regions whose correspondence is obtained, and a three-dimensional position of the face of the pedestrian M from the door 3. The position of the face of the pedestrian M from the door 3 is obtained based on a positional relationship of the face of the pedestrian M from the camera 11 by using positional relationship between the camera 11 and the door 3 obtained in advance.

The identification target selector module 15 acquires a face region (face image) and three-dimensional position of the face which are outputs from the face distance measuring module 14, and determines the face region targeted for face identification. In the case where a face region is obtained from a person who exists in the image capturing area 4, the face region is targeted for identification. In the case where a plurality of persons exist in the image capturing region 4, the face region of the person who is closer to the door 3 is preferentially targeted for identification.

In the case where a three-dimensional position of the face region targeted for identification has drastically changed from a previous frame, it is determined that person targeted for identification has been changed, and then, an identification face number is incremented. The identification face number used here indicates a sequential number of a person targeted for identification. The initial value is “0”, and is incremented in the case where a new person is targeted for identification. The display identification control module 23 which carries out processing operation upon the receipt of an output from the identification target selector module 15 recognizes that a person targeted for identification has been changed due to a change of the identification face number.

The face identification module 19 determines whether or not the face regions from the identification target selector module 15 (or face image captured by the short distance camera 18) has been registered in advance. Specifically, as described in, for example, Jpn. Pat. Appln. KOKAI Publication No. 2001-266152, a face image of a registrant (pedestrian) is prepared in advance, and specific characteristic information extracted from such face images are stored (registered) as dictionary entries in the face recognition dictionary 17. Then, the image (characteristic information) in the face regions selected by the identification target selector module 15 are compared with dictionary entries registered in advance in the face recognition dictionary 17, and the likelihood between them is obtained. In the case where the obtained likelihood value is equal to or greater than a preset threshold value, it is determined that the pedestrian M has been registered in advance. In the case where the obtained likelihood value is less than the threshold value, it is determined that the pedestrian M has not been registered in advance.

The gate control module 20 opens the door 3 when a passing enable signal from the display identification control module 23 is turned on in the case where a control target is the door 3, as shown in FIG. 1. In addition, the gate control module 20 operates in accordance with a flowchart shown in FIG. 10 in the case where a control target is the gateway unit 5, as shown in FIG. 2.

Namely, when the passing enable signal from the display identification control module 23 is turned ON (step 1: YES), after a person has been passed through the gateway unit 5 (step 2: YES), the gate control module 20 transmits passing completion information to the display identification control module 23 (step 3). On the other hand, in the case where a person has passed through the gateway unit 5 although the passing enable signal is turned off (step 1; NO and step 2: YES), the gate display module 20 sounds warning, closes a flapper provided at the gateway unit 5 (step 3), and inhibits passing of the person.

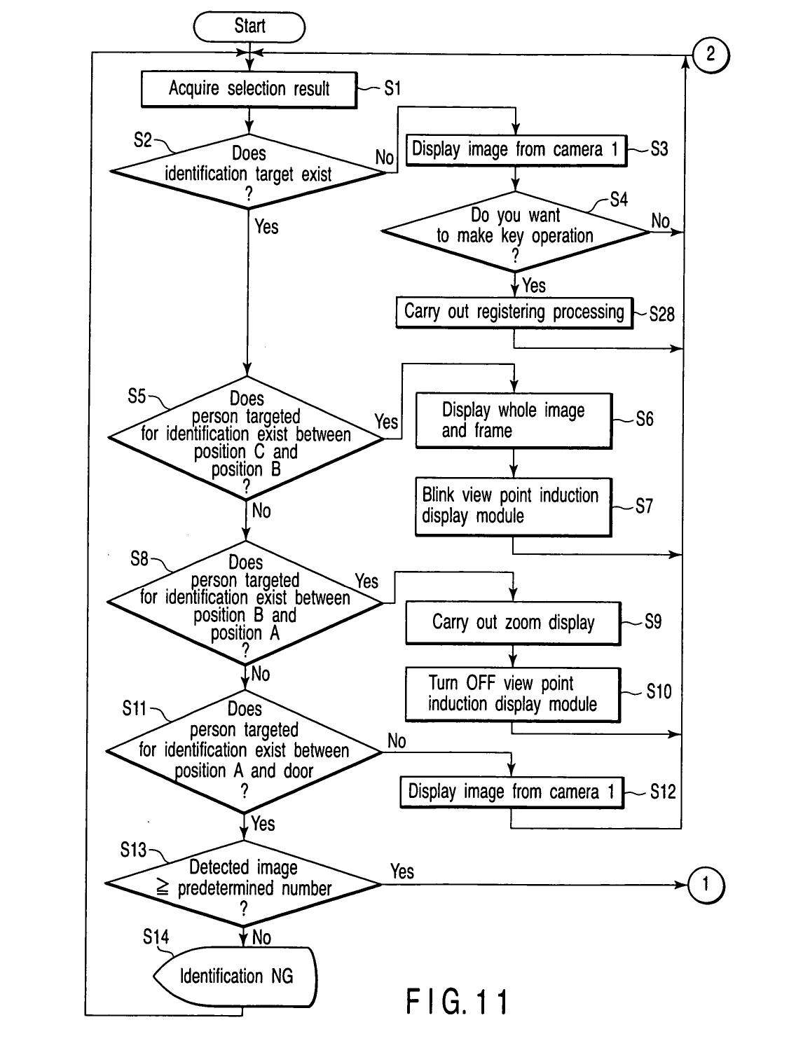

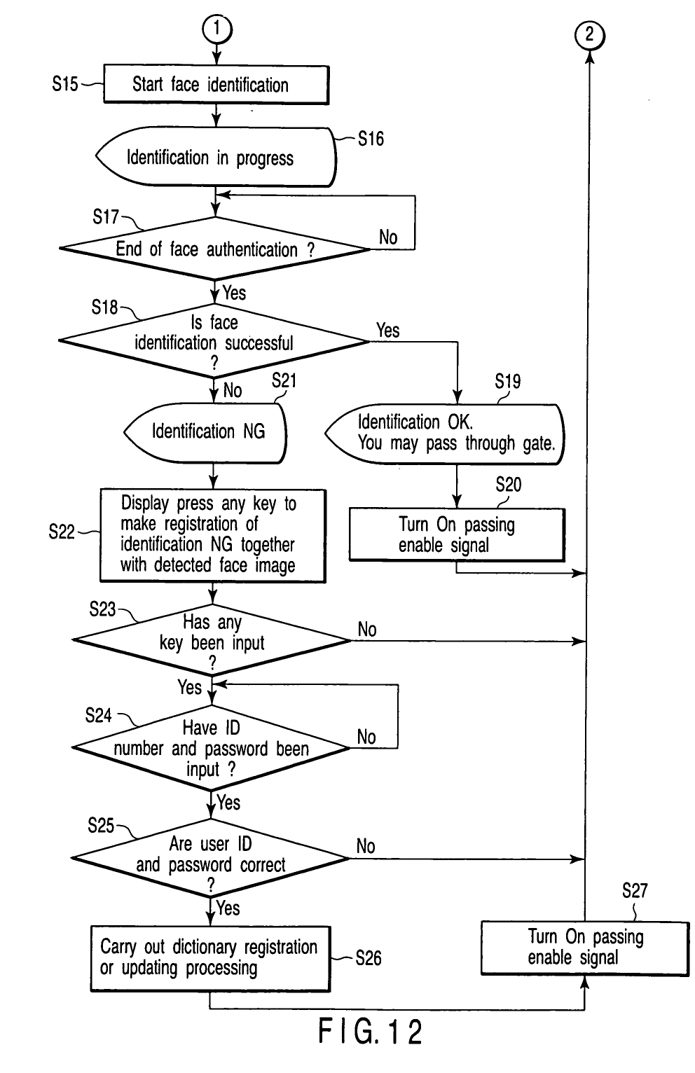

The display identification control module 23 controls a whole operation of the entrance and exit management apparatus. A flow of the processing operation is shown in flowcharts of FIGS. 11 and 12. Now, a processing operation by the display identification control module 23 will be described with reference to the flowcharts of FIGS. 11 and 12.

First, the display identification control module 23 (hereinafter, simply referred to as control module 23) acquires a selection result of the identification target selector module 15 (FIG. 11 and step 1), and checks whether or not a person targeted for identification exists in the image capturing area 4 (step 2). In the case where, as a result of the check in step 2, it is determined that nobody exists in the image capturing area 4 (step 2: NO), the control module 23 displays images captured by the camera 11, i.e., an image indicating that nobody exists via the face identification module 21 (step 3).

At the same time, the control module 23 checks whether or not any key operation has been made by the operating module 16 (step 4). In the case where, as a result of the check in step 4, the control module 23 determines that no key operation is made (step 4; NO), the current processing reverts to step 1.

Before the above-described processing operation in step 1, the control module 23 may blink the LED of the view point induction display module 22, or alternatively, may operate the illumination display module 36 described in FIG. 6. In this manner, in the case where there is a pedestrian M who moves to the door 3 or gateway unit 5, there is a high possibility that the pedestrian M enters the walking area 1 in a state in which he or she orients a direction of the face identification display module 21. In addition, there is a high possibility that frontal images of the pedestrian M can be captured immediately after the pedestrian M has entered the walking area 1.

In the meantime in the case where, as a result of the check in step 2, it is determined that a person targeted for identification (pedestrian M) exists in the image capturing area 4 (step 2: YES), the control module 23 checks whether or not the pedestrian M exists between the position C and the position B of the walking area 1 (step 5).

In the case where, as a result of the check in step S5, a person targeted for identification, namely, a pedestrian M exists between the position C and the position B (step 5: YES), the control module 23 displays a whole image as shown in FIG. 5A via the face identification display module 21. At this time, the control module 23 also displays a rectangle 42 indicating a detected face region on the same screen at the same time (step 6).

Further, at this time, the control module 23 operates the LED of the view point induction display module 22 to blink (step 7) and/or operates the illumination display module 36, and prompts the pedestrian M to pay attention and orient his or her face to the face identification display module 21. Namely, in accordance with the processing operations in step 6 and step 7, the pedestrian M moves his or her view point to the face identification display module 21 without walking with his or her face down.

On the other hand, in the case where, as a result of the check in step 5, it is determined that a pedestrian M does not exist between the position C and the position B (step 5: NO), the control module 23 checks whether or not the pedestrian M exists between the position B and the position A of the walking area 1 (step 8).

In the case where, as a result of the check in step 8, the pedestrian M exists between the position B and the position A (step 8: YES), the control module 23 displays an image obtained by enlarging a face of the pedestrian M via the face identification display module 21, as shown in FIG. 5B (step 9).

At this time, the control module 23 turns off the LED of the view point induction display module 22 (step 10) so that the view point of the pedestrian M is not located at the view point induction display module 22. Namely, in the case where the pedestrian M approaches the cameras 11 and 12, the view point induction display module 22 is turned off so as not to pay attention to the view point induction display module 22 allocated at the periphery of the face identification display module 21, i.e., so as not to change a face direction of the pedestrian M facing the camera 11.

At this time, in the case where the illumination display module 36 allocated at the periphery of the liquid crystal display module 31 is operated, the operation of the illumination display module 36 may not always be stopped. Namely, in a state in which the pedestrian M pays attention to the illumination display module 36, there is a high possibility that the face of the pedestrian M is oriented to the direction of the face identification display module 21 (i.e., camera 11). Thus, there is a low possibility that the face direction of the pedestrian M changes.

Further, in the case where, as a result of the check in step 8, it is determined that the pedestrian M does not exist between the position B and the position A (step 8: NO), the control module 23 checks whether or not the pedestrian M exists between the position A of the walking area 1 and the door 3 (step 11).

In the case where, as a result of the check in step 11, it is determined that the pedestrian M does not exist between the position A of the walking area 1 and the door 3 (step 11: NO), the control module 23 displays via the face identification display module 21 an image captured via the camera 11 (step 12).

On the other hand, as a result of the check in step 11, in the case where it is determined that the pedestrian M exists between the position A of the walking area 1 and the door 3 (step 11: YES), the control module 23 checks whether or not the number of detected face images of the pedestrian M (targeted for identification) is equal to or greater than a predetermined number (step 13). The predetermined number of images used here denotes a required minimum number of images for face identification of the pedestrian M, and can be arbitrarily set according to a length of the walking area 1, i.e., an image capturing time of the pedestrian M.

In the case where, as a result of the check in step 13, it is determined that a predetermined number or more of face images targeted for identification have not been successfully acquired (step 13: NO), the control module 23 displays for a predetermined period of time, a message “identification NG” which indicates that identification has failed, as shown in FIG. 5E, via the face identification display module 21 (step 14).

On the other hand, in the case where, as a result of the check in step 13, it is determined that a predetermined number or more of face images targeted for identification have been successfully acquired (step 13: YES), the control module 23 sends to the face identification module 19 images (face images) of the face regions selected by the identification target selector module 15, and starts face identification processing operation (FIG. 12 and step 15). At this time, the control module 23 displays a message indicating that “identification is in progress” as shown in FIG. 5C via the face identification display module 21, and waits until the face identification processing operation in the face identification module 19 has terminated (step 17).

When the face identification processing operation terminates (step 17: YES), the control module 23 checks whether or not identification has succeeded (step 18). In the case where it is determined that identification has succeeded (step 18: YES), a message “Identification OK, you may pass through gate” as shown in FIG. 5D is displayed via the face identification display module 21 (step 19). At the same time, the control module 23 turns ON for a predetermined period of time a passing enable signal to be transmitted to the gate control module 20 (step 20). In this way, the pedestrian M can pass through the door 3 or gateway unit 5.

On the other hand, in the case where, as a result of the check in step 18, it is determined that identification has failed (step 18: NO), the control module 23 displays for a predetermined period of time a message “identification NG” as shown in FIG. 5E via the face identification display module 21 (step S21).

Then, the control module 23 displays the detected face image, as shown in FIG. 5F, via the face identification display module 21. In addition, in the case where registration is made as a result of “identification NG”, the control module 23 displays for a predetermined period of time a message which prompts the pedestrian M to input a key such as “Identification NG. Press any key when you want to make registration” (step 22). If no key input is made within a predetermined period of time (step 23: NO), the current processing reverts to step 1.

On the other hand, when a key is inputted via the operation module 16 within a predetermined period of time (step 23: YES), the control module 23 displays a message screen for prompting the pedestrian M to enter an ID number and a password, and waits for an operation input by the pedestrian M (step 24).

Then, when the ID number and the password have been inputted via the operation module 16 (step 24: YES), the control module 23 checks whether or not the inputted ID number and password are correct (step 25). In the case where it is determined that the inputted ID and password are correct (step 25: YES), a processing operation for registering dictionary information described later (or updating processing operation) is carried out (step 26).

At this time, by making the user carry a wireless card including pedestrian ID information instead of making the user input the ID number or password, ID may be read from the wireless card.

Alternatively, at this time, the control module 23 may permit only passing of the pedestrian M without accepting the dictionary information registering processing operation (or updating processing operation) after checking the ID number and password. For example, in the case where a comparatively large number of users utilize the area 2 and there is no time for accepting registering and updating processing operations, such a processing operation is effective, and a processing mode may be changed as required.

In any case, after checking the ID number and password, the control module 23 turns on for a predetermined period of time a passing enable signal with respect to the gate control module 20 (step 27), and permits the passing of the pedestrian M.

In the meantime, as a result of the check in step 4, in the case where any key is pressed and in the case where the current processing reverts to step 26, the control module 23 carries out a processing operation for registering dictionary information with respect to the pedestrian M (step 28).

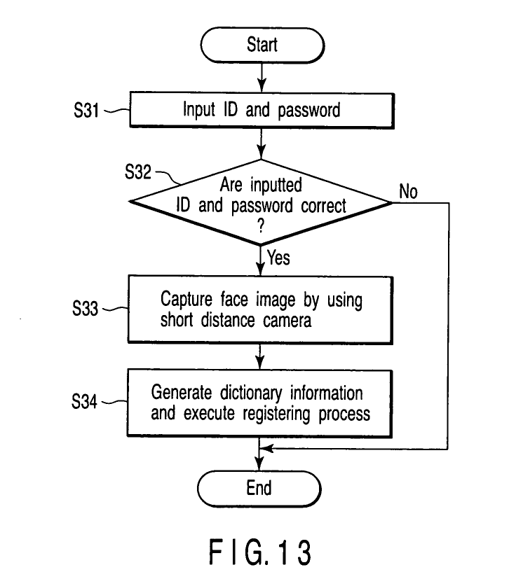

Now, a processing operation for registering dictionary information in step 28 will be described with reference to a flowchart shown in FIG. 13.

In the registering processing operation in step 28, the control module 23 first accepts inputs of an ID number and a password (step 31). However, in the case where the current processing reverts to step 26 described above, this processing operation in step 31 is skipped. Next, the control module 23 checks whether or not the input ID number and password are correct (step 32), and terminates the registering processing operation if they are not correct.

When the user ID and password are correct as a result of the check in step 32, the control module 23 captures the face of the pedestrian M as images by the short distance camera 18 in accordance with an image capturing condition for the face correlating device or the like, and acquires face images (step 33). Alternatively, at this time point, in the case where the face image of the pedestrian M has been successfully acquired, this face image may be utilized.

Then, the control module 23 extracts specific characteristic information from the obtained face image, and stores (registers or updates) the extracted characteristic information as a dictionary entry in the face recognition dictionary 17 (step 34).

The above-described image capturing condition may include that strong light irradiates from one side at the periphery of the face identification apparatus. In this case, for example, an illumination light provided at the face identification display module 21 is brightened only on one side, a similar state is reproduced in a simulative manner.

As has been described above, according to the above embodiment, in the case where the pedestrian M exists in a predetermined distance range (image pickup region 4) from the door 3 (gateway unit 5), the cameras 11 and 12 and the face identification display module 21 are allocated so as to be arranged on a straight line viewed from the pedestrian M, and is designed to capture face images. Thus, the pedestrian M watches the face identification display module 21, whereby face images can be stably picked up from the frontal face of the pedestrian M. Consequently, identification performance is remarkably improved.

In the above embodiment, in the case where the pedestrian M is comparatively distant from the door 3, a whole image is displayed, and a face region of the pedestrian M at this time is displayed on the face identification display module 21 while the face region is enclosed in a frame 42. When the pedestrian M approaches the door 3 in a predetermined distance, the enlarged region of the face image is displayed. Thus, the pedestrian M can easily check whether or not he or she is targeted for identification. In this manner, the pedestrian M is recognizant of facing the camera 11.

In addition, according to the above embodiment, the face identification display module 21 for displaying a face image of the pedestrian M is placed in the vicinity of the door 3 and the view point induction display module 22 is placed in front of the pedestrian M (i.e., at the door 3) or the illumination display module 36 is operated with a proper timing so as to prompt the pedestrian M to effectively view the face identification display module 21. Thus, the pedestrian M easily perceives the face identification display module 21 so as to view the face identification display module 21 with stopping facing down.

Namely, in the embodiment, the frontal face images of the pedestrian M are easily captured by the camera 11 and a time for capturing the face of the pedestrian M as images can be comparatively extended, so that a required number of frontal face images effective for identification can be acquired. Further, when the pedestrian M approaches the door 3 to a predetermined extent, the frontal view point induction display module 22 is turned OFF. Consequently, the pedestrian M pays attention to only the face identification display module 21 for displaying a face, thereby making it possible to stably capture frontal face images of the pedestrian M. Therefore, identification performance is remarkably improved.

Moreover, in the above embodiment, two cameras 11 and 12 are intensively allocated at the upper and lower portions with being spaced from each other so as to calculate a distance from a viewing difference between the two cameras 11 and 12 to the pedestrian M and to make an identification process and a display control according to the calculated distance. At the same time, a face image closer to a frontal face of the pedestrian M with his or her face down is captured by using the lower camera 12. In this manner, the control module 23 can recognize a distance from each of the cameras 11 and 12 to the pedestrian M, and make control according to a distance from the door 3 to the pedestrian M. Namely, according to the embodiment, a user interface is improved.

Furthermore, according to the embodiment, face identification is carried out by using the face images obtained until the pedestrian M has approached the cameras 11 and 12. When face identification has failed, the operation module 16 installed in the vicinity of the door 3 is operated by using the obtained image, thereby making it possible to register or update dictionary information. In this manner, face images obtained at the time of walking can be efficiently utilized for registration even in the case where identification has failed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A face identification apparatus for, by the time a moving person reaches a specific position, identifying the face of the person, the apparatus comprising:
a camera which captures images including at least a face of the moving person;
a face detector module which detects face regions of the person from the images captured by the camera;
a face identification module which compares images of the face regions detected by the face detector module with dictionary entries which have been registered in advance, thereby determining whether or not the person has been registered in advance; and
a face identification display module installed in the vicinity of the camera, the display module displaying the current state of the face identification with respect to the moving person, wherein the camera captures the frontal face images of the person moving to the specific position while the person is viewing the face identification display module.

2. A face identification apparatus according to claim 1, further comprising: a face distance measuring module which calculates the distance of the moving person from the specific position, wherein
the face identification display module changes display images based on the result of the face distance measuring module.

3. A face identification apparatus according to claim 2, wherein the face identification display module displays the images captured by the camera with face regions bounded by rectangles, in the case where the distance of the moving person from the specific position is greater than a predetermined value, and displays the enlarged face region of the person in the case where the moving person approaches the specific position and the distance of the person from specific position becomes smaller than the predetermined value.

4. A face identification apparatus according to claim 1, further comprising: a view point induction display module which prompts the moving person to view the face identification display module.

5. A face identification apparatus according to claim 4, wherein the view point induction display module includes an illumination display module allocated in a frame shape at the periphery of the face identification display module.

6. A face identification apparatus according to claim 4, wherein the view point induction display module operates even when a person moving to the specific position does not exist.

7. A face identification apparatus according to claim 4, further comprising: a face distance measuring module which calculates the distance of the moving person from the specific position, wherein
the view point induction display module operates based on a result of the face distance measuring module.

8. A face identification apparatus according to claim 7, wherein the view point induction display module gets activated in the case where the distance of the moving person from the specific position is greater than a predetermined value, and gets deactivated in the case where the moving person approaches the specific position and the distance of the person from the specific position becomes smaller than the predetermined value.

9. A face identification apparatus according to claim 1, wherein
the camera has at least an upper camera installed so that the face of the moving person is captured as images, and a lower camera installed beneath the upper camera, and
the face detector module detects the face regions of the person from each of the images captured by the upper and lower cameras.

10. A face identification apparatus according to claim 9, further comprising:
a face distance measuring module which calculates the distance of the person from the camera based on each of the images captured by the upper and lower cameras; and
an identification target selector module which selects an optimal face region targeted for identification based on the result of the face detector module and a result of the face distance measuring module, wherein
the face identification module compares images of the face regions selected by the identification target selector module with dictionary entries which have been registered in advance, thereby determining whether or not the person has been registered in advance.

11. A face identification apparatus according to claim 1, further comprising: an operation module which, in the case where by the face identification module, it is determined that the person has not been registered in advance, accepts an operation input for registering the person to the dictionary or updating the dictionary by using images captured at the time of the face identification.

12. A face identification apparatus according to claim 11, further comprising: a short distance camera which captures a face of a person who operates the operation module as an image.

13. A face identification apparatus according to claim 11, wherein the images captured at the time of the identification are images of the face region detected by the face detector module while the person moves.

14. A face identification apparatus for, by the time a moving person reaches a specific position, identifying the face of the person, the apparatus comprising:
a camera which captures images including at least a face of the moving person;
a face detector module which detects face regions of the person from the images captured by the camera;
a face identification module which compares the images of the face regions detected by the face detector module with dictionary entries which have been registered in advance, thereby determining whether or not the person has been registered in advance;
a face identification display module installed in the vicinity of the camera, the display module displaying the current state of the face identification with respect to the moving person; and
a face distance measuring module which calculates a distance of the moving person from the specific position, wherein
the camera is installed at a position at which the face of the person moving to the specific position is captured as images from a frontal face while the person is viewing the face identification display module, and
the face identification display module changes display images based on the result of the face distance measuring module.

15. A face identification apparatus according to claim 14, wherein the face identification display module displays the images captured by the camera with face regions bounded by rectangles, in the case where the distance of the moving person from the specific position is greater than a predetermined value, and displays a enlarged face region of the person in the case where the moving person approaches the specific position and the distance of the person from specific position becomes smaller than the predetermined value.

16. A face identification apparatus according to claim 14, further comprising: a view point induction display module which prompts the moving person to view the face identification display module.

17. A face identification apparatus according to claim 16, wherein the view point induction display module includes an illumination display module allocated in a frame shape at the periphery of the face identification display module.

18. A face identification apparatus according to claim 16, wherein the view point induction display module is activated even when a person moving to the specific position does not exist.

19. A face identification apparatus according to claim 16, wherein the view point induction display module operates based on the result of the face distance measuring module.

20. A face identification apparatus according to claim 19, wherein the view point induction display module gets activated in the case where the distance of the moving person from the specific position is greater than a predetermined value, and gets deactivated operation in the case where the person approaches the specific position and the distance of the person from specific position becomes smaller than the predetermined value.

21. An entrance and exit management apparatus for, by the time a moving person reaches an entrance and exit gate provided in an entrance and exit target area, identifying the face of the person, and controlling the entrance and exit gate to be opened or closed based on a result of the face identification module, the management apparatus comprising:
a camera which captures images including at least a face of the moving person;
a face detector module which detects face regions of the person from the images captured by the camera;
a face identification module which compares the image regions of the face detected by the face detector module with dictionary entries which have been registered in advance, thereby determining whether or not the person has been registered in advance;
a face identification display module provided in the vicinity of the camera, the display module displaying the current state of face identification with respect to the moving person; and
gate control means for controlling the entrance and exit gate to be opened or closed based on a result of the face identification module,
wherein the camera is installed at so that the face of the person moving to the entrance and exit gate is captured as images from a frontal face while the person is viewing the face identification display module.

22. An entrance and exit management apparatus according to claim 21, further comprising: a face distance measuring module which calculates the distance of the moving person from the entrance and exit gate, wherein
the face identification display module changes a display image based on a result of the face distance measuring module.

23. An entrance and exit management apparatus according to claim 22, wherein the face identification display module displays the images captured by the camera with face regions bounded by rectangles, in the case where the distance of the moving person from the entrance and exit gate is greater than a predetermined value, and displays the enlarged face region of the person in the case where the moving person approaches the specific position and the distance of the person from specific position becomes smaller than the predetermined value.

24. An entrance and exit management apparatus according to claim 21, further comprising: a view point induction display module which prompts the moving person to view the face identification display module.

25. An entrance and exit management apparatus according to claim 24, wherein the view point induction display module includes an illumination display module allocated in a frame shape at the periphery of the face identification display module.

26. An entrance and exit management apparatus according to claim 24, wherein the view point induction display module operates even when a person moving to the entrance and exit gate does not exist.

27. An entrance and exit management apparatus according to claim 24, further comprising: a face distance measuring module which calculates the distance of the moving person from the entrance and exit gate, wherein
the view point induction display module operates based on the result of the face distance measuring module.

28. An entrance and exit management apparatus according to claim 27, wherein the view point induction display module gets activated in the case where the distance of the moving person from the entrance and exit gate is greater than a predetermined value, and gets deactivated in the case where the moving person approaches the entrance and exit gate and the distance of the person from the specific position becomes smaller than the predetermined value.

29. An entrance and exit management apparatus according to claim 27, wherein
the apparatus has at least an upper camera installed at so that a face of the moving person is captured as images, and a lower camera installed beneath the upper camera, and
the face detector module detects the face regions of the person from each of the images captured by the upper and lower cameras, respectively.

30. An entrance and exit management apparatus according to claim 29, further comprising:
a face distance measuring module which calculates the distance of the person from the camera based on each of the images captured by the upper and lower cameras; and
an identification target selector module which selects an optimal face region targeted for identification based on the result of the detection in the face detector module and the result of the face distance measuring module, wherein
the face identification module compares the image on the face region selected by the identification target selector module with dictionary entries which have been registered in advance, thereby determining whether or not the person has been registered in advance.

31. An entrance and exit management apparatus according to claim 21, further comprising: an operation module which, in the case where the face identification module determines that the person has not been registered in advance, accepts an input operation for registering the person to the dictionary or updating the dictionary by using images obtained at the time of the identification.

32. An entrance and exit management apparatus according to claim 31, further comprising: a short distance camera which captures a face of a person who operates the operation module as an image.

33. An entrance and exit management apparatus according to claim 31, wherein the image obtained at the time of the identification is an image on the face region detected by the face detector module while the person moves.
